(19) United States
(12) Patent Application Publication
(10) Pub. No.: US 2016/0196419 A1
(43) Pub. Date: Jul. 7, 2016

(54) MULTI-ACTION LOCK SCREEN

(71) Applicant: Google Inc., Mountain View, CA (US)

(72) Inventor: Alexander Friedrich KUSCHER, San Francisco, CA (US)

(21) Appl. No.: 14/590,846

(22) Filed: Jan. 6, 2015

(51) Int. Cl. G06F 21/36; G06F 3/0482; G06F 3/0481

(52) U.S. Cl. CPC G06F 21/36; G06F 3/04817; G06F 3/0482

(57) ABSTRACT

Aspects of the subject technology relate to a lock screen having multiple available actions. A computer-implemented method includes displaying a lock screen having a first user icon corresponding to a first user account and a second user icon corresponding to a second user account. The method further includes displaying a first notification icon, the first notification icon corresponding to a notification of a first application for the first user icon. The first notification icon is positioned closer to the first user icon than the second user icon. The method further includes receiving an input command targeting the first notification icon. The method further includes unlocking the device and executing the first application on the device, in response to the received input.

### BACKGROUND

The present disclosure relates generally to a lock screen for a device.

Computing devices, such as laptops, tablets, and mobile devices, may lock in order to prevent unauthorized use or access. A locked computing device may display a lock screen to indicate the locked state. To use the locked computing device, the user may input an unlock command, such as inputting a password or inputting an identifiable unlock gesture. However, the user may want to receive notifications without having to unlock the computing device. For example, the user may want to be notified of incoming messages, emails, or other notifications. In addition, the computing device may be used by other users.

### SUMMARY

Aspects of the subject technology relate to a lock screen for a device having multiple user accounts, the lock screen presenting notification icons for unlocking to associated applications. The device may include a display, an input device, one or more processors, and a memory. The memory may include instructions stored therein, which, when executed by the one or more processors, cause the one or more processors to perform operations. The operations may include displaying a lock screen on the display in association with a locked state of the device. The lock screen may include a first user icon and a second user icon, the first user icon corresponding to a first user account, and the second user icon corresponding to a second user account. The operations may also include displaying a first notification icon, the first notification icon corresponding to a notification of a first application for the first user account. The operations may also include displaying a second notification icon, the second notification icon corresponding to a notification of a second application for the first user account. The operations may also include receiving an input command from the input device targeting the first notification icon and the second notification icon. The operations may also include unlocking the device and executing the first application and the second application on the device, in response to the received input.

Aspects of the subject technology also relate to a computer-implemented method. The computer-implemented method may include displaying a lock screen in association with a locked state of a device. The lock screen may include a first user icon and a second user icon. The first user icon may correspond to a first user account, and the second user icon may correspond to a second user account. The computer-implemented method may also include displaying a first notification icon. The first notification icon may correspond to a notification of a first application for the first user account. The computer-implemented method may also include receiving an input command targeting the first notification icon. The computer-implemented method may also include unlocking the device and executing the first application on the device, in response to the received input.

Aspects of the subject technology also relate to a non-transitory, computer-readable storage medium containing instructions that cause a computer system executing the instructions to display a lock screen in association with a locked state of the computer system. The lock screen may include a first user icon and a second user icon. The first user icon may correspond to a first user account. The second user icon may correspond to a second user account. The instructions may also cause the computer system to display a first notification icon. The first notification icon may correspond to a notification of a first application for the first user account. The first notification icon may be positioned closer to the first user icon than the second user icon. The instructions may also cause the computer system to receive an input command targeting the first notification icon. The instructions may also cause the computer system to unlock the computer system and execute the first application on the computer system, in response to the received input.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1A illustrates a lock screen according to example aspects of the present disclosure;

FIG. 1B illustrates a gesture for unlocking the lock screen of FIG. 1A according to example aspects of the present disclosure;

FIG. 1C illustrates a second gesture for unlocking the lock screen of FIG. 1A according to example aspects of the present disclosure;

FIG. 1D illustrates a third gesture for unlocking the lock screen of FIG. 1A according to example aspects of the present disclosure;

FIG. 2 illustrates a workspace according to example aspects of the present disclosure;

FIG. 3A is a flowchart illustrating a process of unlocking a lock screen according to example aspects of the present disclosure;

FIG. 3B is a flowchart illustrating a process of unlocking a lock screen directly to two applications according to example aspects of the present disclosure; and

FIG. 4 shows a diagram of an electronic system according to example aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

In accordance with one or more implementations, methods and systems for a lock screen are disclosed. The lock screen displays user icons corresponding to user accounts for a computing device, and displays notification icons for notifications of the user accounts. The user icon may be a pictogram or may be for example, one or more photos, videos, text, or other representations of the user and/or user account. The user accounts may be separate accounts for each user, or may be different account types for one or more users. For example, a user may have a work account and a personal account on the same device. The user accounts may be accessible by more than one user, for example a guest account or other shared account. The lock screen of the subject technology displays a user icon for each user account associated with the device, which allows for a user associated with any one of the user accounts to unlock the device from the lock screen. The lock screen also displays notification icons corresponding to notifications associated with the user accounts. The notification icons may be pictograms, photos, videos, text, timestamps, or other forms of information to convey the associated notification. Multiple notification icons may be displayed for each user account, allowing associated users to see recent notifications from the lock screen. The user may also unlock the device directly into the one or more applications which generated the notifications.

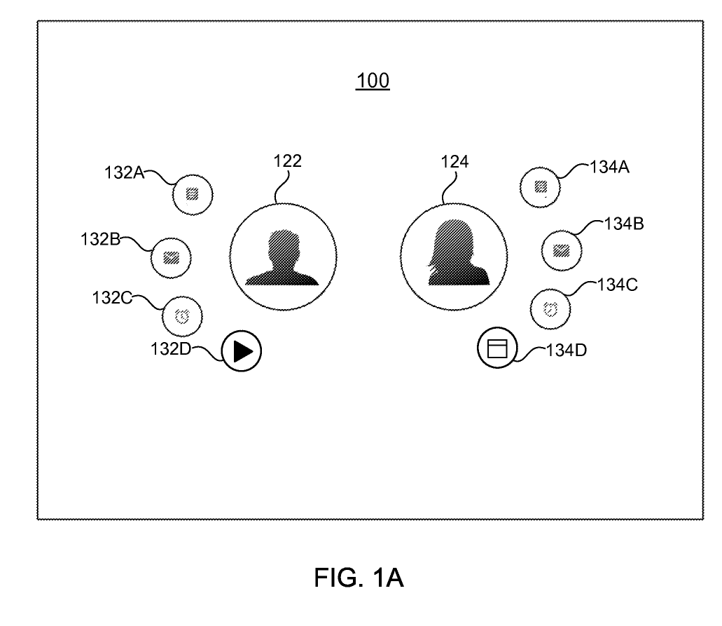

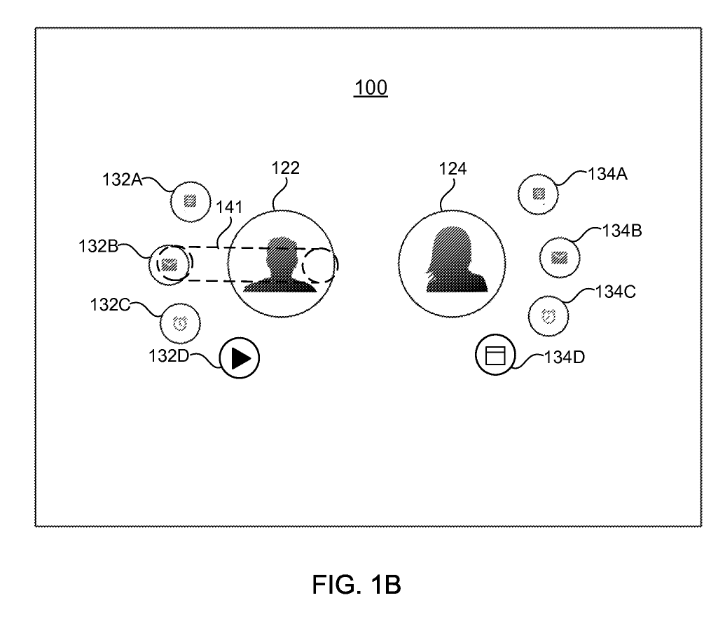

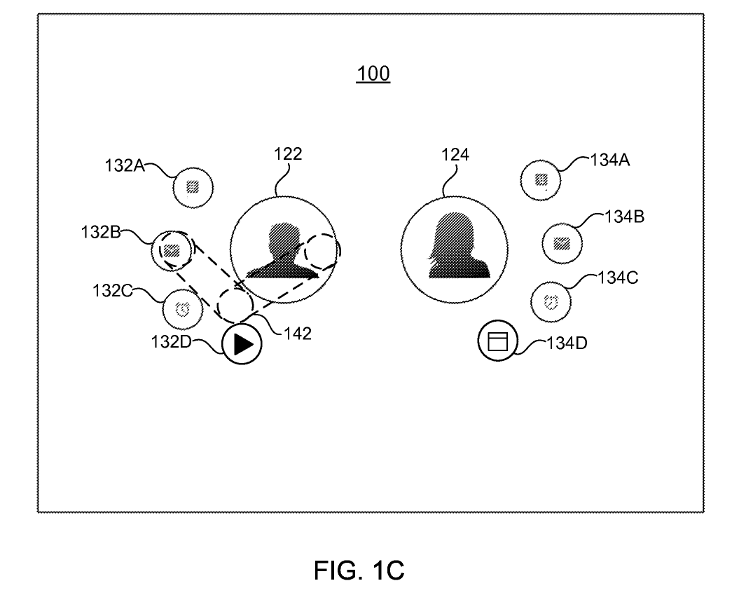

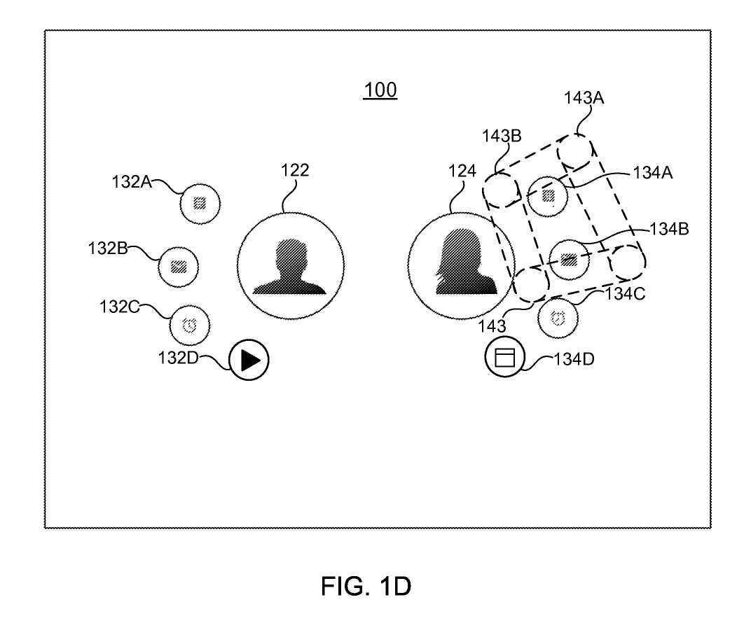

FIG. 1A shows a lock screen 100 of a device according to example aspects. The device may be a tablet, laptop, mobile device, or other electronic device having one or more users, and a lock screen for displaying a locked state of the device, in which certain functionalities of the device are disabled. The device may be locked when the device has been idle for an idle threshold period, when the display has been shut off and subsequently turned on, when the device is first booted, when a user has logged off or is switching between users, as a power saving measure, or other similar circumstances in which it is desirable to disable functionality of the device. The functionality may be disabled as a security measure to prevent unauthorized access, or may be disabled in order to ignore certain user inputs when user inputs are not expected, such as when the user has logged off. Unlocking the device from the lock screen 100 returns the device to an unlocked state without disabled functionality. The device may return to a state the device was in before the locked state, or may return to a home screen or other default state. Unlocking the device may be in the context of unlocking the local device, unlocking to a local network, unlocking to a wide area network, or unlocking into a cloud service. The device may be unlocked in association with a user account, and may therefore require a password input. The password input may comprise the user identifying himself and may also comprise the user inputting a specific password or passphrase, a specific gesture or input command, selecting a specific option from a group of options, a biometric input, connecting a specific hardware device, or other uniquely identifiable input in order to validate the user.

The lock screen 100 includes a first user icon 122, a second user icon 124, a first user notification icon 132A, a first user notification icon 132B, a first user notification icon 132C, a first user notification icon 132D, a second user notification icon 134A, a second user notification icon 134B, a second user notification icon 134C, and a second user notification icon 134D.

The lock screen 100 may display on a display of the device when the device is locked. The device may lock passively, such as after a period of inactivity, or actively, such as the user locking the device. The lock screen 100 provides an interface for an authorized user to unlock the device. Each user account of the device may have a corresponding user icon displayed on the lock screen 100. A first user may have a first user account which is associated with the first user icon 122. A second user may have a second user account which is associated with the second user icon 124. Alternatively, the first user may be associated with both the first and second user accounts, or more than one user may be associated with each account. The first user icon 122 and the second user icon 124 may be spaced apart to provide space for notification icons such as the first user notification icons 132A-D and the second user notification icons 134A-D. The first user and/or the second user may be able to set privacy settings in order to convey more or less information with the notifications, for example to display less information such that other users of the device would not see full notifications of the first or second user. For instance, a generic icon representing a general notification without identifying the associated application may be displayed.

The notification icons are arranged around the corresponding user icon to indicate which user account the notification applies to. For instance, the first user notification icons 132A-D are arranged closer to the first user icon 122 whereas the second user notification icons 134A-D are arranged closer to the second user icon 124. In FIG. 1A, the notification icons are generally arranged radially around the corresponding user icon. The notification icons may be rearranged as new notifications are generated. In certain implementations, the notification icons may appear after one of the user icons are selected such that the lock screen 100 originally displays the first user icon 122 and the second user icon 124. Once one of the user icons are selected, the corresponding notification icons may be shown.

In other implementations, the user notification icons' associations with the respective user accounts may be conveyed in other ways. For example, a line may connect a user notification icon to the associated user icon. The user notification icons may be color coordinated with the associated user icon. The user icon may be presented with each user notification icon. The user notification icons may be hidden under the user icon until the user icon is selected. The user icon may cycle through associated user notification icons. The user notification icons may be presented as a ticker tape or banner near the associated user icon.

The lock screen 100 may be unlocked by a user inputting a command which targets a user icon and/or notification icon. For example, the first user may target the first user icon 122 by clicking on or tapping on the first user icon 122, and may be prompted for a password or other identifiable input for verifying the first user. In certain implementations, once a user icon is selected, the lock screen 100 may display the corresponding notification icons as well as a password prompt.

The user may input a gesture in order to unlock the lock screen 100. To prevent accidental unlocking, such as through interpreting inadvertent touches or inputs as a gesture, a length of the gesture may be determined. The length of the gesture may be measured as a distance, such as the distance continuously swiped or dragged measured in pixels or window/screen distance. A gesture length threshold may be implemented. Inputs shorter than the gesture length threshold may be inadvertent touches and therefore not interpreted as a gesture. The gesture length threshold may alternatively be determined by time, such that too quick of an input may not be interpreted as a gesture. In addition, the location of the input may be determined. A meaningful gesture may be near or on an icon whereas an input near random portions of the lock screen 100, away from icons, may not be interpreted as a gesture.

The user may also unlock directly into an application. Unlocking directly into an application unlocks the device, and rather than returning to a home screen, the device executes the application. The user may see a seamless transition from the lock screen 100 to the application screen. The user may input a command targeting a notification icon to unlock directly into the application associated with the targeted notification icon. FIG. 1B illustrates a gesture 141 for unlocking the lock screen 100 directly into an application. The gesture 141 may be a finger swipe input or mouse drag input between the first user notification icon 132B and the first user icon 122 such that the first user notification icon 132B is targeted. The first user notification icon 132B may correspond to a notification from an email application. The first user may swipe from the first user icon 122 to the first user notification icon 132B, or from the first user notification icon 132B to the first user icon 122 in order to unlock the lock screen 100 directly into the email application. Alternatively, the first user may drag the first user notification icon 132B to the first user icon 122 in order to unlock the lock screen 100 directly into the email application. The gesture 141 may target the first user notification icon 132B by starting or ending at the first user notification icon 132B. The gesture 141 may also similarly target the first user icon 122. Targeting the first user icon 122 may be optional in certain implementations, because the first user notification icon 132B is associated with the first user and not to another user or user icon. A password input may also be required before the application is shown. The lock screen 100 is unlocked and the email application is executed in response to the gesture 141.

Alternatively, the user swipe or gesture may act as a password. A specific swipe pattern between the first user icon 122 and at least one of the first user notification icons 132A-D may be recognized as a password gesture for unlocking the lock screen 100. The password gesture may be, for example, a sine or other curve, a zigzag shape, or other continuous motion uniquely identifiable and associated with the user similar to a password. Once a pattern or shape of the user input is determined, it may be compared against a password pattern associated with the user. The password gesture may be considered a match with the password pattern within a tolerance threshold such that the user is not required to recreate the password pattern exactly.

FIG. 1C illustrates a password gesture 142. The password gesture 142 resembles a zigzag shape based on the user inputting a zigzag patter with a finger swipe or mouse drag. The first user targets the first user notification icon 132B with the password gesture 142 starting or ending at the first user notification icon 132B. In certain implementations, the password gesture 142 may require targeting the corresponding user icon, the first user icon 122. The password gesture 142 may be recognized as a pattern, such as a zigzag, and may unlock the device if the pattern matches a password pattern for the user. In certain implementations, the device may unlock to a home screen if a notification icon is not targeted by the password gesture 142.

The user may also unlock directly to more than one application. For instance, the second user may target the second user notification icons 134A and 134B to open the respective applications. The second user may select (by clicking or tapping) the second user icon 124, which may prompt the second user to select one or more of the notification icons. When multiple touch inputs can be detected, the second user may selection multiple icons by simultaneously dragging multiple icons into the second user icon 124, or by tapping the multiple icons. The second user may also target multiple icons by dragging one notification icon into one or more other notification icons. Because the second user notification icons 134A-D are associated with the second user account, a selection of the second user icon 124 may not be needed.

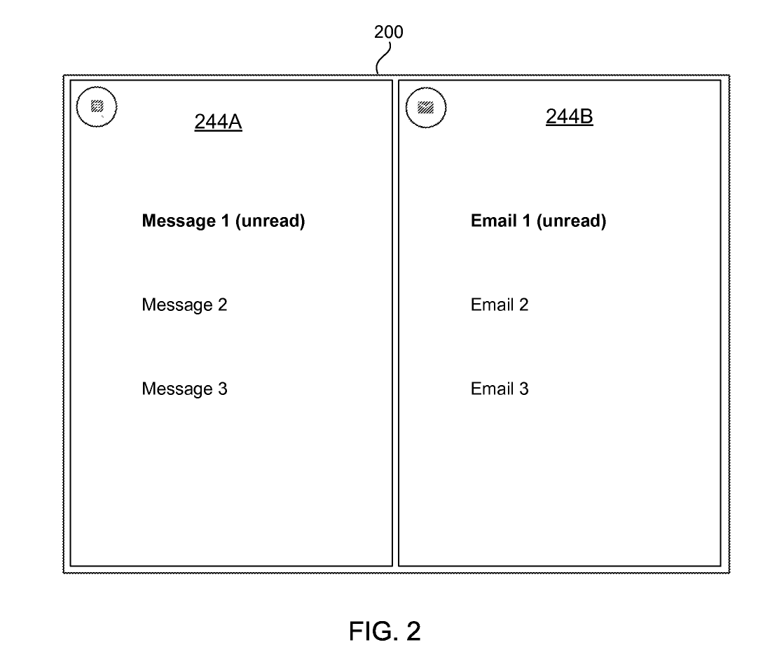

Alternatively, the second user may use a lasso gesture around the desired notification icons. FIG. 1D shows a lasso gesture 143 which targets the second user notification icons 134A and 134B by encircling the second user notification icons 134A and 134B. The lasso gesture 143 may be recognized as encircling the second user notification icons 134A and 134B by detecting that the swipe input or mouse drag outlines a path around or encircling the targeted notification icons. The path may require a closed loop, such as the lasso gesture 143. The lasso gesture 143 may start at, for point 143A, and also end at point 143A to close the path. In certain implementations, the path may end near a starting point of the path such that an area outlined by the path includes at least a portion of the targeted notification icons. For example, the path may start at point 143A and end at point 143B, such that the area within the path contains the second user notification icons 134A and 134B. In certain implementations, the second user may be prompted for a password after targeting notification icons. The applications associated with the second user notification icons 134A and 134B may be opened directly from unlocking the lock screen 100. The applications may be opened in a workspace, or may be opened in a split screen. The lasso gesture 143 unlocks the lock screen 100 directly into a workspace 200 in FIG. 2. Although the lasso gesture 143 targets two applications, more or less applications may be targeted.

FIG. 2 shows the workspace 200 of including application 244A and an application 244B after the lasso gesture 143 of FIG. 1D targeted the second user notification icons 134A and 134B. The application 244A, which may be a messaging application, corresponds to the second user notification icon 134A. The application 244B, which may be an email application, corresponds to the second user notification icon 134B. The applications 244A and 244B may have new content or otherwise have an updated status, which generated the notification icons 134A and 134B, respectively, on the lock screen 100. In FIG. 2, the targeted applications are shown side-by-side. In other implementations, the applications may be shown in other configurations, such as top-to-bottom, tiled windows, cascaded windows, or other user configurable layouts for displaying multiple applications. Although FIG. 2 shows two applications, more or less applications may be shown, corresponding to the notification icons targeted by the lasso gesture 143.

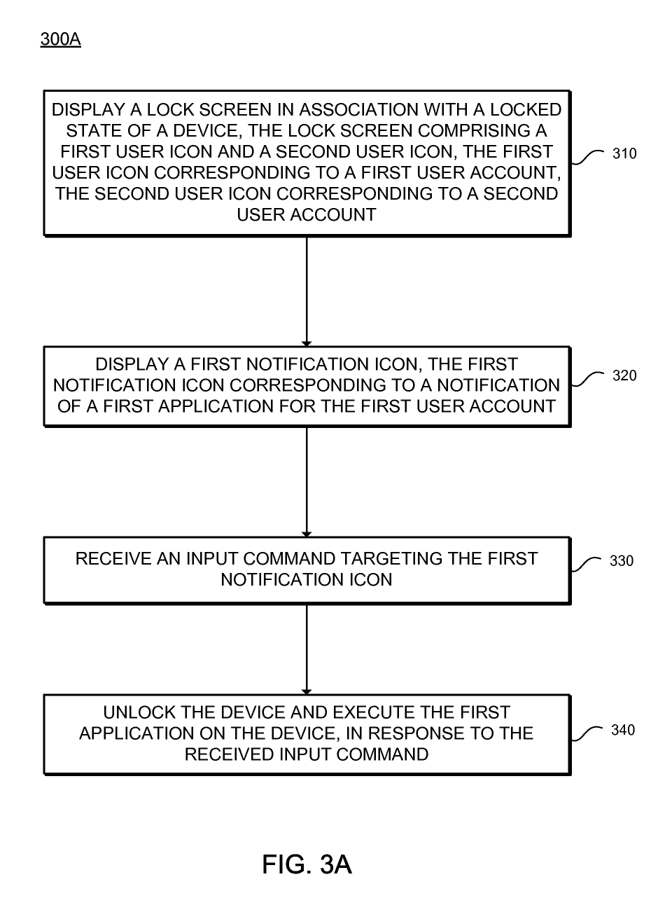

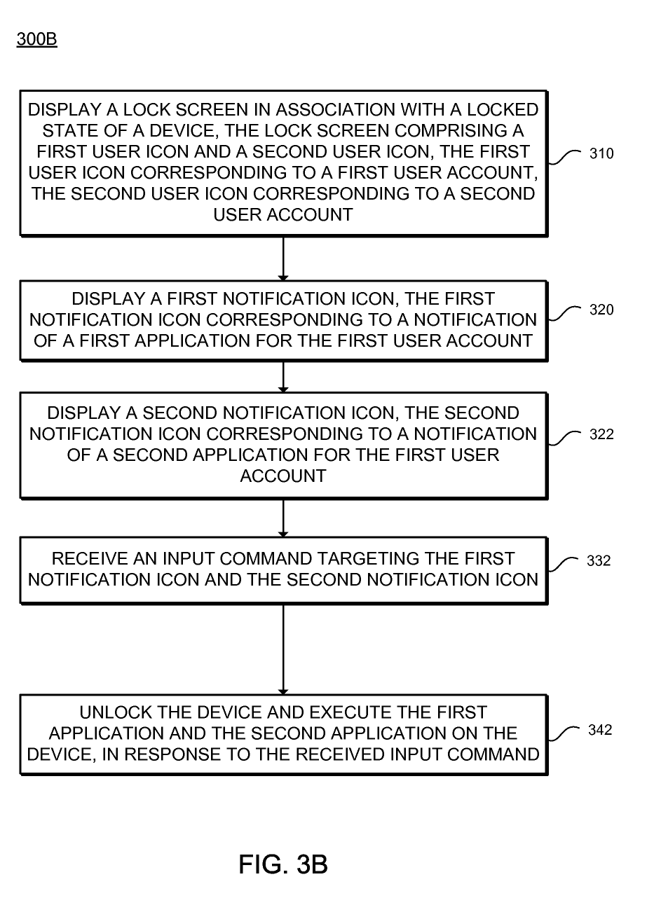

FIG. 3A shows a flowchart 300A illustrating a method for unlocking a lock screen, such as the lock screen 100, according to aspects. At block 310, the lock screen is displayed in association with a locked state of a device. The lock screen comprises a first user icon and a second user icon. However, more than two user icons, when there are more than two user accounts, may be accordingly displayed. The first user icon corresponds to a first user account, and the second user icon corresponds to a second user account. The lock screen may be displayed in response to an input turning on a display of the device when in the locked state.

At block 320, a first notification icon is displayed. The first notification icon corresponds to a notification of a first application for the first user account. The association between the first notification icon and the first user icon may be represented by positioning the first notification icon closer to the first user icon than the second user icon. Alternatively, a line may connect the first notification icon with the first user icon, or the first notification icon and first user icon may have corresponding colors (such as an outline or background). The first notification icon may be displayed in response to the first user icon being selected, such that notification icons are displayed for the selected user icon only. Alternatively, the first notification icon may be displayed when the notification is generated, such that multiple application notifications for the first user may generate corresponding notification icons near or around the first user icon. Successive notification icons may surround the corresponding user icon, and may shift to make room for additional notification icons, or may be statically positioned around the user icon.

At block 330, an input command targeting the first notification icon is received. The input command may be a gesture which targets the first notification icon by starting or ending at the first notification icon. In certain implementations, the gesture may target more than one notification icon.

At block 340, the device is unlocked and the first application is executed in response to the received input. In certain implementations, a password may be required before unlocking the device. The password may be separately prompted, or the input received at block 330 may be recognized as a password gesture. If more than one notification icon was targeted at block 330, the device may unlock and execute multiple applications corresponding to the targeted notification icons.

FIG. 3B shows a flowchart 300B illustrating a method for unlocking a lock screen, such as the lock screen 100 as seen in FIG. 1D, according to aspects. The blocks 310 and 320 may be similar to the blocks 310 and 320 of FIG. 3A. At block 322, a second notification icon is displayed. The second notification icon corresponds to a notification of a second application for the first user account. Similar to the first notification icon, the association between the second notification icon and the first user icon may be represented by positioning the first notification icon closer to the first user icon than the second user icon, or other suitable ways, such as a line or color code. The second notification icon may be displayed after the first notification icon, for example in chronological order of the times the first and second notifications are generated. Alternatively, the notification icons may be displayed in batches, such that the notification icons displayed are periodically updated. In certain implementations, the first user may have a setting which determines how often notification icons are displayed, such as in real-time, periodically (e.g., every 10 minutes), at specific times set by the user, or in response to a user action such as turning on the display or selecting the first user icon. Although two notification icons are described, more notification icons may be displayed.

At block 332, an input command targeting the first notification icon and the second notification icon is received. The input command may be a gesture which targets the first notification icon and the second notification icon by lassoing or encircling the first notification icon and the second notification icon. In certain implementations, the first and second notification icons may be targeted by dragging the first and second notification icons onto the first user icon or into each other, or to another common area. The first and second notification icons may be dragged with a password gesture. For example, the first notification icon may be dragged to the second notification icon, then the first and second notification icons further dragged with the password gesture. Alternatively, the first and second notification icons may both be dragged simultaneously with the password gesture. Although two notification icons are described as targeted, more notification icons may be targeted.

At block 342, the device is unlocked and the first application and the second application are executed in response to the received input. In certain implementations, a password may be required before unlocking the device. The password may be separately prompted, or the input received at block 332 may be recognized as a password gesture. The device may unlock and execute multiple applications corresponding to the targeted notification icons by displaying the applications in a single workspace, such as a splitscreen view. Alternatively, the multiple applications may be displayed as windows, tabs, or other view in which the multiple applications are running Although two applications are described in block 342, more applications may be executed, corresponding to the targeted notification icons.

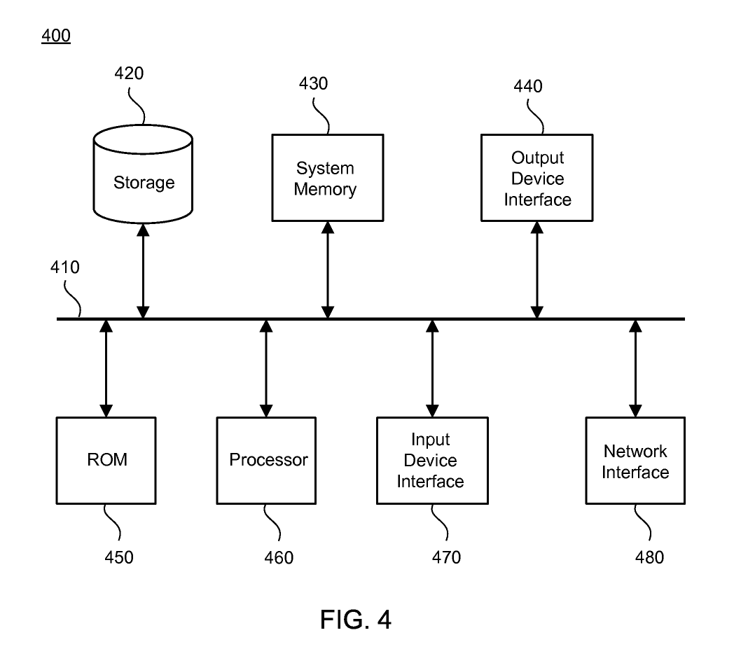

FIG. 4 conceptually illustrates an example electronic system with which some implementations of the subject technology can be implemented. Electronic system 400 can be a computer, phone, PDA, laptop, tablet, mobile device, or any other sort of electronic device having multiple user accounts, and having a locked state function. Such an electronic system includes various types of computer readable media and interfaces for various other types of computer readable media. Electronic system 400 includes a bus 410, processing unit(s) 460, a system memory 430, a read-only memory (ROM) 450, a permanent storage device 420, an input device interface 470, an output device interface 440, and a network interface 480.

Bus 410 collectively represents all system, peripheral, and chipset buses that communicatively connect the numerous internal devices of electronic system 400. For instance, bus 410 communicatively connects processing unit(s) 460 with ROM 450, system memory 430, and permanent storage device 420.

From these various memory units, processing unit(s) 460 retrieves instructions to execute and data to process in order to execute the processes of the subject disclosure. The processing unit(s) can be a single processor or a multi-core processor in different implementations.

ROM 450 stores static data and instructions that are needed by processing unit(s) 460 and other modules of the electronic system. Permanent storage device 420, on the other hand, is a read-and-write memory device. This device is a non-volatile memory unit that stores instructions and data even when electronic system 400 is off Some implementations of the subject disclosure use a mass-storage device (for example, a magnetic or optical disk and its corresponding disk drive) as permanent storage device 420.

Other implementations use a removable storage device (for example, a floppy disk, flash drive, and its corresponding disk drive) as permanent storage device 420. Like permanent storage device 420, system memory 430 is a read-and-write memory device. However, unlike storage device 420, system memory 430 is a volatile read-and-write memory, such as a random access memory. System memory 430 stores some of the instructions and data that the processor needs at runtime. In some implementations, the processes of the subject disclosure are stored in system memory 430, permanent storage device 420, or ROM 450. For example, the various memory units include instructions for displaying a lock screen with multiple user icons and corresponding notification icons, and unlocking directly into selected applications. From these various memory units, processing unit(s) 460 retrieves instructions to execute and data to process in order to execute the processes of some implementations.

Bus 410 also connects to input and output device interfaces 470 and 440. Input device interface 470 enables the user to communicate information and select commands to the electronic system. Input devices used with input device interface 470 include, for example, alphanumeric keyboards and pointing devices (also called “cursor control devices”). Output device interfaces 440 enables, for example, the display of images generated by the electronic system 400. Output devices used with output device interface 440 include, for example, printers and display devices, for example, cathode ray tubes (CRT) or liquid crystal displays (LCD). Some implementations include devices, for example, a touchscreen that functions as both input and output devices.

Finally, as shown in FIG. 4, bus 410 also couples electronic system 400 to a network (not shown) through a network interface 480. In this manner, the computer can be a part of a network of computers (for example, a local area network (LAN), a wide area network (WAN), or an Intranet, or a network of networks, for example, the Internet. Any or all components of electronic system 400 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage, and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

1. A device comprising:
a display;
an input device;
one or more processors; and
a memory comprising instructions stored therein, which, when executed by the one or more processors, cause the one or more processors to perform operations, the operations comprising:
displaying a lock screen on the display in association with a locked state of the device, the lock screen comprising a first user icon and a second user icon, the first user icon corresponding to a first user account, the second user icon corresponding to a second user account;
displaying a first notification icon, the first notification icon corresponding to a notification of a first application for the first user account;
displaying a second notification icon concurrently with the first notification icon, the second notification icon corresponding to a notification of a second application for the first user account, the second application different from the first application;
receiving an input command from the input device, the input command indicating simultaneous selection of the first notification icon and the second notification icon; and
unlocking the device for the first user account based at least on recognizing the input command as an unlocking gesture and simultaneously displaying the first application and the second application on the device, in response to the received input command.

2. The device of claim 1, wherein unlocking the device requires receiving the input command that matches a password pattern associated with the first user account.

3. The device of claim 1, wherein unlocking the device requires receiving the input command comprising a gesture having a gesture length greater than a gesture length threshold.

4. The device of claim 1, wherein the first notification icon is positioned closer to the first user icon than the second user icon.

5. The device of claim 1, wherein the second notification icon is positioned closer to the first user icon than the second user icon.

6. The device of claim 1, the operations further comprising displaying the first application and the second application in a workspace.

7. A computer-implemented method, comprising:
displaying a lock screen in association with a locked state of a device, the lock screen comprising a first user icon and a second user icon, the first user icon corresponding to a first user account, the second user icon corresponding to a second user account;
displaying a first notification icon spaced apart from a second notification icon, the first notification icon corresponding to a notification of a first application for the first user account, the second notification icon corresponding to a notification of a second application for the first user account, the second application independent from the first application;
displaying a third notification icon spaced apart from a fourth notification icon, the third notification icon corresponding to a notification of a third application for the second user account, the fourth notification icon corresponding to a notification of a fourth application for the second user account;
receiving an input command selecting the third notification icon and the fourth notification icon;
recognizing the input command as an unlocking gesture; and
unlocking the device for the second user account based at least on the recognition and an association between the selected third and fourth notification icons and the second user account and displaying the third application on the device, in response to the received input command.

8. The method of claim 7, wherein the first notification icon is positioned closer to the first user icon than the second user icon.

9. The method of claim 7, wherein unlocking the device requires receiving the input command that matches a password pattern associated with the first user account.

10. The method of claim 7, wherein unlocking the device requires receiving the input command comprising a gesture having a gesture length greater than a gesture length threshold.

11. The method of claim 7, wherein the second notification icon is positioned closer to the first user icon than the second user icon.

12. (canceled)

13. (canceled)

14. The method of claim 7, further comprising displaying the first application and the second application in a workspace.

15. A non-transitory, computer-readable storage medium containing instructions that cause a computer system executing the instructions to:
display a lock screen in association with a locked state of the computer system, the lock screen comprising a first user icon and a second user icon, the first user icon corresponding to a first user account, the second user icon corresponding to a second user account;
display a first notification icon, the first notification icon corresponding to a notification of a first application for the first user account, the first notification icon positioned closer to the first user icon than the second user icon;
display a second notification icon concurrently with the first notification icon, the second notification icon corresponding to a notification of a second application for the first user icon, the second application independent from the first application;
receive an input command simultaneously selecting the first notification icon and the second notification icon; and
unlock the computer system for the first user account based at least on an association between the selected first and second notification icons and the first user account and recognizing the input command as an unlocking gesture and display the first application next to the second application on the computer system, in response to the received input command.

16. The non-transitory, computer-readable storage medium of claim 15, wherein unlocking the computer system requires receiving the input command that matches a password pattern associated with the first user account.

17. The non-transitory, computer-readable storage medium of claim 15, wherein the second notification icon is positioned closer to the first user icon than the second user icon.

18. (canceled)

19. (canceled)

20. The non-transitory, computer-readable storage medium of claim 15, further comprising instructions that cause the computer system to display the first application and the second application in a workspace.
